(19) United States
(12) Patent Application Publication
(10) Pub. No.: US 2007/0057995 A1
(43) Pub. Date: Mar. 15, 2007

(54) Hybrid ink jet image forming apparatus having a platen formed with a maintenance unit

(75) Inventor: Young-choon Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/501,694

(22) Filed: Aug. 10, 2006

(30) Foreign Application Priority Data
Sep. 15, 2005 (KR) 2005-86244

(51) Int. Cl. B41J 2/155

(52) U.S. Cl. 347/42

(57) ABSTRACT

A hybrid ink jet image forming apparatus is provided. The hybrid ink jet image forming apparatus includes: a shuttle printing head which linearly reciprocates perpendicular to a feeding direction of a paper to form an image; an array printing head which includes a nozzle portion having the same width of the paper to form an image; a first platen which is disposed under the shuttle printing head in a rotating manner, supports a feeding paper, and includes a capping unit for capping the array printing head; a second platen which is disposed under the array printing head in a manner that can linearly reciprocate along with the feeding direction of the paper and supports the feeding paper; and a driving means which changes the position of the first platen, horizontally moves the second platen, and caps the nozzle portion of the array printing head by the capping unit.

### CROSS-REFERENCE TO RELATED APPLICATIONS

This application claims priority under 35 U.S.C. §119(a) from Korean Patent Application No. 10-2005-0086244, filed on Sep. 15, 2005, in the Korean Intellectual Property Office, the disclosure of which is incorporated herein in its entirety by reference.

### BACKGROUND OF THE INVENTION

1. Field of the Invention

The present general inventive concept relates to an ink jet image forming apparatus having a platen formed with a maintenance unit, and more particularly, to a hybrid ink jet image forming apparatus having a shuttle printing head and an array printing head.

2. Description of the Related Art

Generally, ink jet image forming apparatuses form an image by dispersing an ink from a printing head (hereinafter referred to as a shuttle printing head) which is separated from the upper surface of a paper by a predetermined distance and reciprocates in a widthwise direction perpendicular to a feeding direction of the paper. Such a printing head includes a nozzle portion having a plurality of nozzles for extracting an ink. Since the shuttle printing head reciprocates in the widthwise direction of the paper to form an image, a printing speed is slow but image quality is good.

Recently, instead of the printing head which reciprocates in the widthwise direction of the paper, a printing head (hereinafter referred to as an array printing head) which includes a nozzle portion having the same width of the paper has been used for an implementation of high speed printing. In such an ink jet image forming apparatus, only the paper is fed since the printing head is fixed. As a result, the ink jet image forming apparatus has a simple driving device and provides the high speed printing. However, image quality may deteriorate due to the high speed printing.

Therefore, a hybrid ink jet image forming apparatus including a shuttle printing head and an array printing head which are selectively or concurrently driven according to a printing condition has been introduced.

Meanwhile, during a process of dispersing an ink onto the paper, foreign materials, such as a non-dispersed ink drop, a solid precipitation that the ink drop is dried, and a fine dust that is attached from the air, may be attached to the nozzle portion, which leads to deterioration of printing quality. In order to maintain good printing quality, a wipe unit is required for removing the foreign material attached to the nozzle portion.

In particular, a length of the nozzle portion of the array printing head is for example approximately 210 mm to correspond to an A4 size paper, if a widthwise printing margin is not taken into consideration. Therefore, a device for effectively removing the foreign material attached to such a long nozzle portion is required. In addition, a capping unit for isolating the nozzle portion from an outside is required to prevent an ink in the nozzle portion from being dried.

Accordingly, the hybrid ink jet image forming apparatus including the shuttle printing head and the array printing head has to be configured such that the wiping unit and the capping unit are not obstructed with each other and entire volume can be minimized.

### SUMMARY OF THE INVENTION

The present general inventive concept provides a hybrid ink jet image forming apparatus which employs a structure of a shuttle printing head for maintenance of an array printing head, thereby reducing a space and a size thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a hybrid ink jet mage forming apparatus including a shuttle printing head which linearly reciprocates in a widthwise direction perpendicular to a feeding direction of a printing medium to form an image, an array printing head which includes a nozzle portion having the same width of the printing medium to form an image, a first platen which is disposed under the shuttle printing head in a rotating manner, supports the printing medium, and includes a capping unit to cap the array printing head, a second platen which is disposed under the array printing head in a manner that can linearly reciprocate along the feeding direction of the printing medium to support the printing medium, and a driving unit which changes a position of the first platen, horizontally moves the second platen, and caps the nozzle portion of the array printing head by the capping unit.

The foregoing and/or other aspects and advantages of the present general inventive concept may also be achieved by providing an image forming apparatus including first and second printing heads, first and second platens to correspond to the first and second printing heads, respectively, and a maintenance unit formed on the first platen to maintain the second printing head.

The foregoing and/or other aspects and advantages of the present general inventive concept may also be achieved by providing an image forming apparatus including a first printing head, a second printing head ,a first platen disposed to form a paper conveying path with the first printing head in a first printing position, and having a first maintenance unit to maintain the second printing head, and a second platen disposed to form the paper conveying path with the second printing head in a second printing position, and having a second maintenance unit to maintain the second printing head.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic perspective view illustrating a hybrid ink jet image forming apparatus according to an embodiment of the present general inventive concept;

FIG. 2 is a schematic rear perspective view illustrating a first platen of the image forming apparatus of FIG. 1;

FIG. 3 is a schematic rear perspective view illustrating a second platen of the image forming apparatus of FIG. 1;

FIG. 4 is a side view illustrating a printing operation of the hybrid ink jet image forming apparatus of FIG. 1; and

FIGS. 5 and 6 are views illustrating operations of wiping and capping of the hybrid ink jet image forming apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

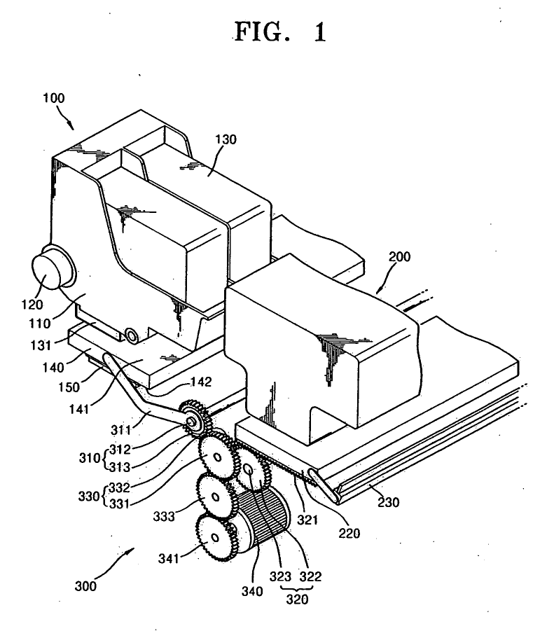

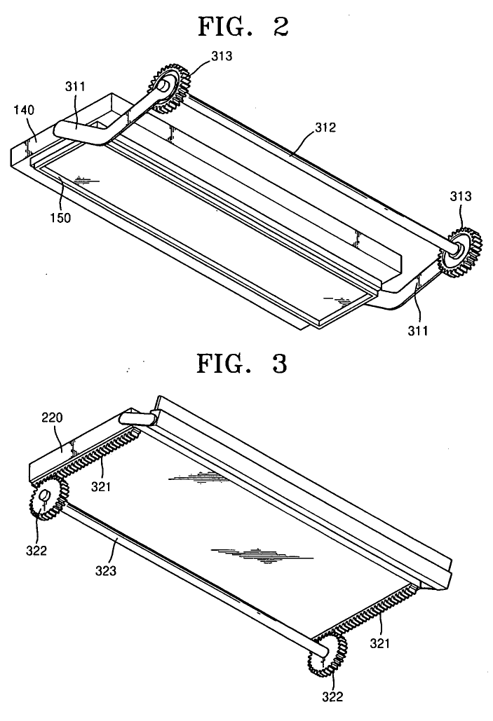

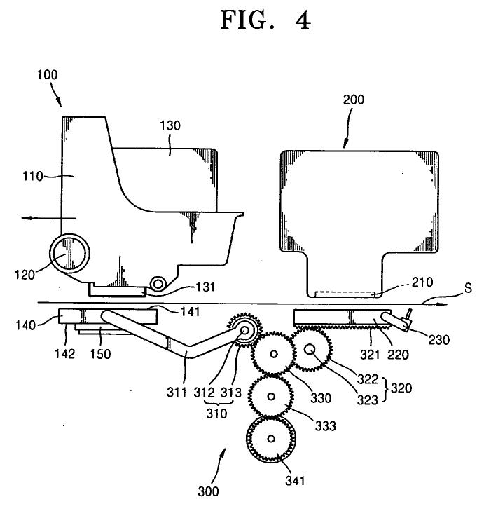

Referring to FIGS. 1 to 4, a hybrid ink jet image forming apparatus includes a shuttle printing head 100, an array printing head 200, a first platen 140, a second platen 220, and a driving unit 300.

The shuttle printing head 100 linearly reciprocates in a widthwise direction perpendicular to a feeding direction of a printing medium, such as a sheet of paper S to form an image onto the paper S and includes a carriage 110 which linearly reciprocates along with a guide shaft 120 and a plurality of ink cartridges 130 which are disposed in the carriage 110 in a detachable manner and store an ink and includes a nozzle portion 131 disposed at a lower side thereof to extract the ink.

The array printing head 200 is separated (spaced-apart) from the shuttle printing head 100 by a predetermined distance in the feeding direction of the paper S, forms an image on the paper S disposed at the lower side thereof, and includes a nozzle portion 210 having the same width of the paper S. When the image has the same width as the paper S, the array printing head 200 can print the image without reciprocating in the widthwise direction. However, the shuttle printing head 100 reciprocates in the widthwise direction to print the image.

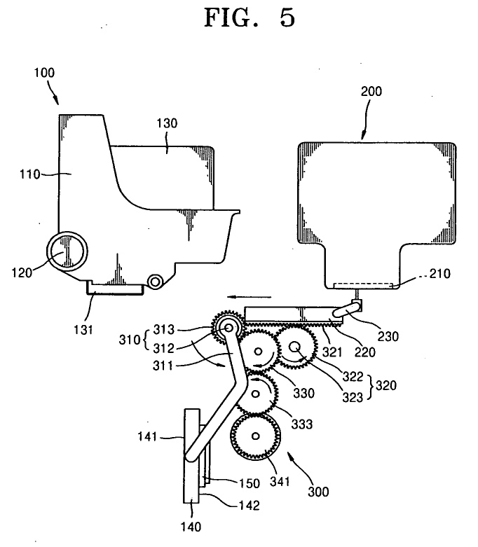

The first platen 140 is disposed at a lower side of the shuttle printing head 100 and supports the feeding paper S. A width of the first platen 140 is equal to or greater than the width of the paper S. The first platen 140 includes a supporting surface 141 to support the paper S, an opposite surface 142 (FIG. 4) opposite to the supporting surface 141 with respect to a first main body of the first platen 140, and a capping unit 150 disposed on the opposite surface 142 to cap the nozzle portion 210 of the array printing head 200. The capping unit 150 may protrude from the opposite surface 142 or may be recessed from the opposite surface 142 to cap the nozzle portion 210 of the array printing head 200.

The second platen 220 is disposed at the lower side of the array printing head 200 and supports the feeding paper S. A width of the second platen 220 is equal to or greater than the width of the paper S. The second platen 220 includes a second main body and a wiping unit 230 disposed on the second main body to wipe out the nozzle portion 210 of the array printing head 200. The second platen 220 may be supported by a frame (not shown) in a sliding manner.

Here, the shuttle printing head 100 has a first length in the widthwise direction, the array printing head 200 has a second length longer than the first length in the widthwise direction, the first and second platens 140 and 220 may have a third length to correspond to the second length in the widthwise direction, and the capping unit 150 may have a fourth length to correspond to the second length of the second printing head to cap the nozzle portion 210 of the array printing head 200.

The driving unit 300 includes a first gear portion 310, a second gear portion 320, and a driving gear portion 330. The driving unit 300 changes a position of the first platen 140, so that the capping unit 150 caps the nozzle portion 210 of the array printing head 200, and controls the second platen 220 to linearly move, so that the wiping unit 230 wipes out the nozzle portion 210 of the array printing head 200.

The first gear portion 310 includes a plurality of first gears 313 disposed at a first rotation shaft 312 which is fixed at an end of arms 311 provided at both sides of the first platen 140. The first gear 313 is engaged with the driving gear portion 330. The first rotation shaft 312 is supported by the frame (not shown) in a rotating manner. The first platen 140 rotates with respect to a rotation axis of the first rotation shaft 312.

The second gear portion 320 includes a plurality of second gears 322 which are respectively engaged with a plurality of rack gears 321 disposed at the lower side of the second platen 220. The second gear 322 is fixed to a second rotation shaft 323. The second gear 322 is engaged with the driving gear portion 330. The second rotation shaft 323 is supported by the frame (not shown) in a rotating manner. The second platen 220 linearly moves according to a movement of the rack gears 321

The driving gear portion 330 is a double gear having a first driving gear 331 and a second driving gear 332. The first driving gear 331 is engaged with the first gear 313, and the second driving gear 332 is engaged with the second gear 322. Meanwhile, the first driving gear 331 is engaged with a middle gear 333 and is thereby engaged with a third driving gear 341 of a driving motor 340 to receive a driving force. The driving gear portion 330 is not necessarily the double gear. The driving gear portion 330 may include one gear engaged with the first and second gears 313 and 322 concurrently.

Operations of capping and wiping the hybrid ink jet image forming apparatus having the aforementioned configuration according to the present embodiment will be described with reference to the drawings.

Referring to FIG. 4, When the image is printed on the paper S, the first platen 140 and the second platen 220 are respectively disposed under the nozzle portion 131 of the shuttle printing head 100 and the nozzle portion 210 of the array printing head 200. It is possible that one of the shuttle printing head 100 and the array printing head 200 prints the image while the other one of the shuttle printing head 100 and the array printing head 200 does not perform the printing operation.

While the paper S is supported by at least one of the first platen 140 and the second platen 220 and is fed in an arrow direction, the image is formed thereon by an ink ejected from the nozzle portion 131 of the shuttle printing head 100 and the nozzle portion 210 of the array printing head 200.

At this time, the wiping unit 230 is disposed under a feeing path of the paper S so as not to obstruct feeding of the paper S.

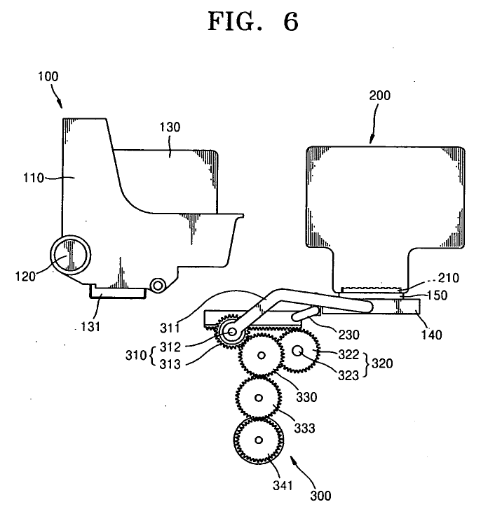

Referring to FIG. 5, after printing is complete, operations of wiping and capping the nozzle portion 210 of the array printing head 200 are carried out.

If the driving motor 340 rotates in a forward direction (in a clockwise rotation of FIG. 5), the driving gear portion 330 is rotated in the forward direction according to a rotation of the middle gear 333, the first gear portion 310 and the second gear portion 320 rotate in opposite direction (a counterclockwise rotation of FIG. 5) opposite to the forward direction.

As the first gear portion 310 rotates in the opposite direction, the first platen 140 is rotated in the counterclockwise direction with respect to a center of the first rotation shaft 312 by the arm 311.

As the second gear portion 320 rotates in the opposite direction, the second platen 220 is moved to a left side direction (a linear arrow direction of FIG. 5) with respect to the array printing head 200. In other word, the second platen 220 horizontally moves towards the shuttle printing head 100. At this time, the second platen 220 and the first gear potion 310 are not obstructed with each other.

Meanwhile, as the second platen 220 is horizontally moved, since the wiping unit 230 comes in contact with the nozzle portion 210 of the array printing head 200, an ink attached on the nozzle portion 210 is wiped out when the wiping unit 230 moves. During the wiping operation, the wiping unit 230 has to be raised over a feeding surface of the paper S. The operation of raising or lowering the wiping unit 230 can be implemented using a mechanism (not shown) according to a movement of the second platen 220.

Referring to FIG. 6, as the second platen 220 is moved out from a paper conveying path under the array printing head 200, the wiping unit 230 is separated from the nozzle portion 210 of the array printing head 200 and completes the wiping operation of wiping out the ink on the nozzle portion 210.

The position of the first platen 140 may be changed by 180 degrees with respect to the first rotation shaft 312, so that the capping unit 150 caps the nozzle portion 210 of the array printing head 200.

During the aforementioned operations are carried out, a printing completion mode and a standby mode are indicated. To resume printing, the apparatus has to return to a state of FIG. 4. To this end, the driving motor 340 is reversely rotated and is operated in opposite way shown in FIGS. 5 and 6 to return the state of FIG. 4. The shuttle printing head 100 may move in the widthwise direction to a rest area which is away from a printing area of the paper conveying path between the first platen 140 and the shuttle printing head 100, so that a maintenance device for the shuttle printing head 100 can perform a maintaining operation on the nozzle portion 131 of the shuttle printing head 100.

At this time, the wiping unit 230 comes in contact with the nozzle portion 210 of the array printing head 200 again and wipes out the nozzle portion 210.

Accordingly, in a hybrid ink jet image forming apparatus of the present embodiment, a first platen for a shuttle printing head and a second platen for an array printing head perform operations of wiping and capping while changing positions each other, so that a driving space can be reduced, resulting in a small sized apparatus. In addition, the first platen for a shuttle printing head includes a capping unit so as to improve the utility of the apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a shuttle printing head which linearly reciprocates in a widthwise direction perpendicular to a feeding direction of a printing medium to form an image;
an array printing head which includes a nozzle portion having the same width of the printing medium to form a second image;
a first platen which is disposed under the shuttle printing head in a rotating manner, supports the printing medium, and includes a capping unit to cap the array printing head;
a second platen which is disposed under the array printing head in a manner that can linearly reciprocate in the feeding direction of the printing medium and supports the printing medium; and
a driving unit which changes a position of the first platen, horizontally moves the second platen, and caps the nozzle portion of the array printing head by the capping unit.

2. The image forming apparatus according to claim 1, wherein the driving unit comprises:
a plurality of arms connected to the first platen, and having a first rotation shaft fixed on both end thereof;
a first gear portion having a plurality of gears fixed to the first rotation shaft of the plurality of arms;
a plurality of rack gears formed on the second platen;
a second gear portion which is engaged with the plurality of rack gears disposed under the second platen;
a driving gear portion which is engaged with the first gear portion and the second gear portion; and
a driving motor connected to the driving gear portion to transfer a driving force from the driving gear portion to the first gear portion and the second gear portion, so that the first platen rotates and the second platen horizontally moves.

3. The image forming apparatus according to claim 2, wherein the second platen comprises a wiping unit which wipes out the nozzle portion of the array printing head.

4. The image forming apparatus according to claim 1, wherein widths of the first platen and the second platen are equal to or greater than the width of the printing medium.

5. The image forming apparatus according to claim 1, wherein the first platen comprises a main body, a supporting surface to support the printing medium, and an opposite surface disposed opposite to the supporting surface with respect to the main body, and the capping unit is disposed at the opposite surface of of the first platen.

6. The image forming apparatus according to claim 1, wherein the shuttle printing head and the array printing head are sequentially disposed in the feeding direction of the printing medium.

7. An image forming apparatus comprising:
first and second printing heads;
first and second platens to correspond to the first and second printing heads, respectively; and
a maintenance unit formed on the first platen to maintain the second printing head.

8. The image forming apparatus according to claim 7, wherein the maintenance unit comprises a capping unit to cap the second printing head.

9. The image forming apparatus according to claim 7, further comprising:
a second maintenance unit formed on the second platen to maintain the second printing unit.

10. The image forming apparatus according to claim 9, wherein the second maintenance unit comprises a wiping unit to perform a wiping operation on the second printing head.

11. The image forming apparatus according to claim 9, further comprising:
a motor unit to move the second platen between a printing position and a wiping position,
wherein the second platen comprises a rack gear to move the second platen according to a rotation of the motor unit.

12. The image forming apparatus according to claim 9, wherein the second maintenance unit protrudes from a portion of the second platen toward the second printing head.

13. The image forming apparatus according to claim 9, wherein the first maintenance unit and the second maintenance unit simultaneously move from a printing position and a maintenance position.

14. The image forming apparatus according to claim 9, wherein one of the first maintenance unit and the second maintenance unit rotates, and the other one of the first maintenance unit and the second maintenance unit linearly moves with respect to the second printing head.

15. The image forming apparatus according to claim 7, further comprising:
a motor; and
a gear unit to transmit a power from the motor to the first platen and the second platen.

16. The image forming apparatus according to claim 15, wherein the gear unit comprises:
a first gear portion to control the first platen to move between a first printing position and a first maintaining position; and
a second gear portion to control the second platen to move between a second printing position and a second maintaining position.

17. The image forming apparatus according to claim 16, wherein the gear unit further comprises:
a driving gear portion to transmit the power to the first gear portion and the second gear portion.

18. The image forming apparatus according to claim 17, wherein the driving gear portion simultaneously transmits the power to the first gear portion and the second gear portion.

19. The image forming apparatus according to claim 16, further comprising:
an arm coupled to the first platen,
wherein the first gear portion comprises a first gear to transmit the power to the arm such that the first platen rotates between a printing position and a maintenance position with respect to a rotation axis of the first gear.

20. The image forming apparatus according to claim 19, wherein the rotation axis is disposed in a position between the first platen and the second platen.

21. The image forming apparatus according to claim 7, further comprising:
a motor unit;
an arm fixedly coupled to the first platen; and
a first gear portion to transmit a power from the motor unit to the arm such that the first platen moves away from the first printing head with respect to the paper conveying path and toward the second printing head with respect to the paper conveying path.

22. The image forming apparatus according to claim 7, wherein:
the first printing head has a first length in a direction;
the second printing head has a second length longer than the first length in the direction;
the first and second platens have a third length to correspond to the second length n the direction; and
the maintenance unit has a fourth length to correspond to the second length of the second printing head n the direction.

23. The image forming apparatus according to claim 22, wherein the maintenance unit moves from a first position corresponding to a printing position of the first platen to a second position corresponding to a printing position of the second platen.

24. An image forming apparatus comprising:
a first printing head;
a second printing head;
a first platen disposed to form a paper conveying path with the first printing head in a first printing position, and having a first maintenance unit to maintain the second printing head; and
a second platen disposed to form the paper conveying path with the second printing head in a second printing position, and having a second maintenance unit to maintain the second printing head.
